(19) United States
(12) Patent Application Publication
(10) Pub. No.: US 2006/0245874 A1
(43) Pub. Date: Nov. 2, 2006

(54) A.T.V. winch anchorage system

(76) Inventors: Kevin Linnen, Regina (CA); Barry J. Kopp, (US); Vance Keeler, (US)

Correspondence Address: Mr. Kevin Linnen, 1140 Albert St, Regina, SK, S4R 2R1, CA

(21) Appl. No.: 11/115,165

(22) Filed: Apr. 27, 2005

(51) Int. Cl. B60P 9/00

(52) U.S. Cl. 414/462

(57) ABSTRACT

A mobile winch anchorage apparatus for All Terrain Vehicles, including a frame assembly, a pair of metal webs (stabilizer legs) attached to the metal frame assembly, a sharpened wedge-ended metal stake and a metal flange with a hole designed to receive and secure the winch line-hook from the All Terrain Vehicle or the like. To use this apparatus, the operator positions the assembly above ground level, forces the sharp end at an angle into the available soft terrain, ensure the support arms are in position to support the winch force, hooks his A.T.V. winch hook into the anchor-receiving flange-hole, then winches his A.T.V. out of the mire, detaining it. The angle the apparatus is driven into the terrain together with the support force of the support stabilizer arms, thereby creates 9 a great stable anchor for the A.T.V. winch (anchor) to, while trying to get the vehicle from a stuck situation to an unstuck position. Once this procedure is complete the apparatus can easily be disassembled and returned to the mobile kit form for easy storage.

### FIELD OF THE INVENTION

The present invention relates generally to apparatus for providing a mobile anchoring support platform, which is able to be positioned easily at the most efficient angle in front of or behind the “stuck” All Terrain Vehicle and the like.

In particular, the present vehicle relates to a mobile, simple, rugged apparatus that will effectively provide a support platform for the A.T.V. winch line to hook to.

This anchor support platform is designed for a maximum strength pull (by winch) by placing it in the ground at the correct angle, then reinforced by stabilizing brackets that provide the triangle of support strength required.

### BACKGROUND OF THE INVENTION

Small All Terrain vehicles are becoming increasingly popular among many sports enthusiasts as well as leisure-pleasure seekers. These A.T.V.'s are used by many people to reach remote areas of the outdoors. Many of these vehicles are designed and promoted for getting in and out of rough terrain. Most enthusiasts like to test the vehicles ability to get thru the biggest and deepest mire they can locate, obviously if the A.T.V. got thru the previous mire, the enthusiast will look for an even more challenging situation. As these situations get more challenging, eventually the A.T.V. enthusiasts get themselves stuck in the most remote and awkward mire. The surroundings may provide a stable and natural support platform (tree) to hook the winch hook to, but in most cases this natural mooring tower will be to far away or at the wrong angle to effectively pull from. If the enthusiast isn't paired up with another A.T.V. operator and the like, he/she usually ends up investing a lot of time and sometimes a lot of money to rescue his A.T.V.

There is very little innovative idea's when searched, to aid in the rescue of this problem of being “stuck” in remote areas.

### SUMMARY OF THE INVENTION

According to its major aspects and broadly stated, the present invention is an apparatus for providing a mobile winch-anchor support platform which enables the winch system of an incapacitated All Terrain Vehicle, to hook into something strong enough, in front or behind, to efficiently pull itself out of the mire.

When the apparatus is positioned for use, the frame assembly is fastened to the sharpened wedge-ended metal stake, which has been driven into the soft terrain. This assembly must be lowered far enough into the ground to enable the stabilizing arms in front to maximize the efficiency by being at the right angle to offset the peek torque generated by the A.T.V.'s winch line.

An important feature of the present invention is the frame assembly which links the ground inserted shaft together with the supporting stabilizer arms, along with the support platform stanchion to supply the complete standing rigging in which to connect the winch line.

### BRIEF DESCRIPTION OF THE DRAWINGS

FIG. 1 A is an exploded view of a A.T.V. Winch Anchorage System according to a preferred embodiment of the present, showing the apparatus in a first stable position,

FIG. 1 B is a top view of the apparatus of FIG. 1 A,

FIG. 1 C is a bottom view of the apparatus of FIG. 1 A,

FIG. 1 D is a side view of the apparatus of FIG. 1 A, in a working stake-below ground, ready for use position.

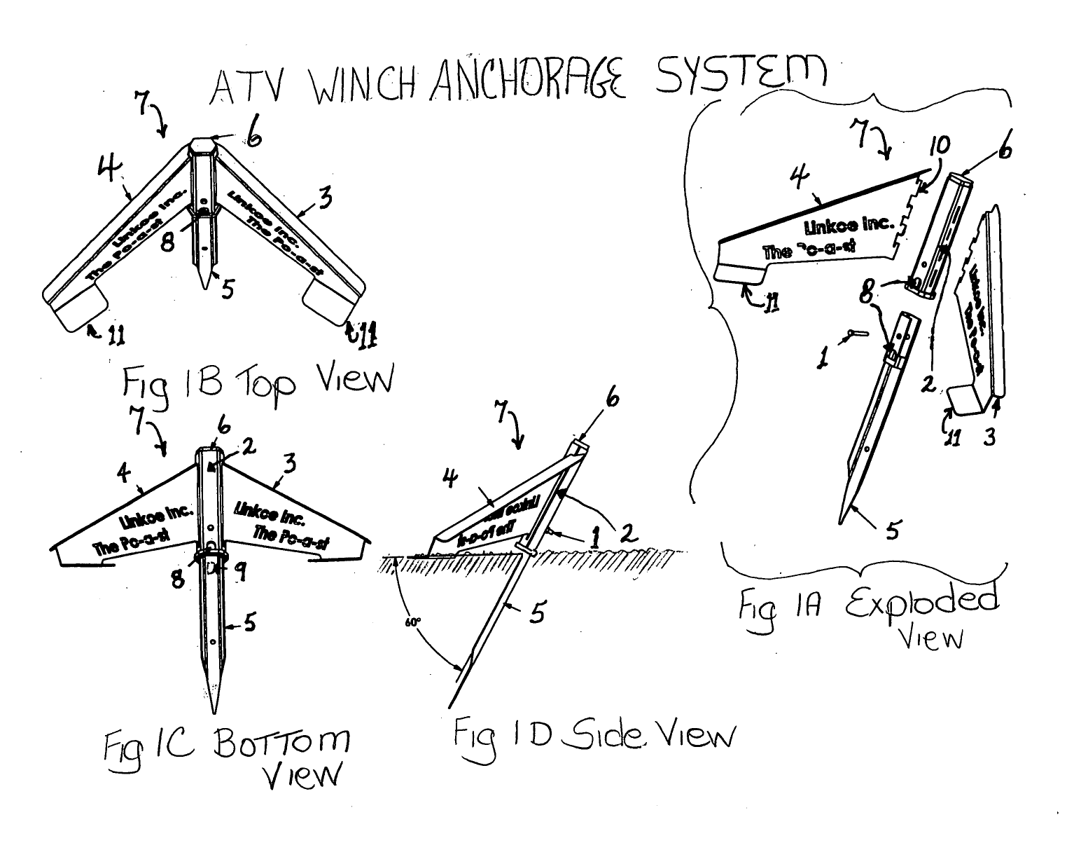

### DETAILED DESCRIPTION OF PREFERRED EMBODIMENTS

Referring to the drawings, a preferred embodiment of the present invention is shown as an A.T.V. Winch Anchorage apparatus 7. Apparatus 7 includes a frame assembly 2 with generally angled stabilizer side supports 3, 4 made with end locks 10 and metal foot tabs 11, solid steel plate 6 welded on top of assembly 2, sharpened wedge-ended metal stake 5, which has a hole 8 designed to match up with the hole 8 in the main frame assembly 2 for which purpose is to receive and secure the winch line-hook from the All Terrain Vehicle. The stabilizer legs 3, 4 are angled at approximately 60 degrees to the front of the frame assembly 2. The strike assembly plate 6 is welded to the top of the main-frame assembly 2 to greatly strengthen the end of the anchorage apparatus 7, which eventually must be driven into the ground for effective use. These components may slide together using effective locking teeth 10 on assemblies 2,3, and 4. The sharpened wedge-ended metal stake 5 is slid upwards into the main-frame assembly 2 and secured by a bolt assembly 1 or other suitable fasteners. Extraction hole 9 is fabricated in the metal stake to be utilized when removing the sharp stake from the ground after use.

After complete assembly the apparatus is then positioned directly in front of or behind the stuck A.T.V., whichever position is most efficient. The complete anchor standing rigging 7 is then driven into the ground, with the wedge-ended metal stake 5, approximately 60 degrees to the horizontal ground level. The assembly system is driven at this angle downward until the metal foot tabs 11 situated on the bottom of the stabilizer supports 3, 4 are planted firmly on the surface of the ground for maximum support.

The operator of the stuck A.T.V. can then anchor the winch line-hook to the hole 8 of the ATV Winch Anchorage System, to commence the steady pull action.

The apparatus greatly improves the odds of the A.T.V. enthusiast's chances of getting unstuck, without outside help in remote areas of our great outdoors.

Since various modifications could be made in my invention as herein above described, and many apparently widely different embodiments of same made within the spirit and scope of the claims without department from such spirit and scope, it is intended that all matter contained in the accompanying specification shall be interpreted as illustrated only and not in a limiting sense.

1. A winch anchoring apparatus for use with an All Terrain Vehicle, having an onboard winch, said apparatus comprising;
Frame means;
Metal web stabilizer legs means attached to said frame means; said metal web stabilizer legs means, positionable so that, as said anchorage system is driven into ground terrain, said metal web stabilizer legs become the forward support system of said winch anchorage system; and
Stake means attached to said frame means; said stake
Means fabricated for ease of penetrating soft terrain at desired angle to maximize said frames ability to provide solid anchoring point for A.T.V's winch hook.

2. The apparatus as recited in claim 1, where in said frame Means further comprises;
Pair of angled apart supports each of said supports having an upper end attached to the frame assembly and a lower end with metal stabilizer webs, positioned to be parallel with the ground when in use.
A sharpened wedge-ended metal stake slid into and attached
At the bottom of the frame by said hexagon bolt, or the like fastener; and a solid steel plate welded on top of the main assembly for striking purposes.

3. The apparatus as recited in claim 1, where in said frame and stake assemblies have pry holes for said winch-line hook to fasten into, to provide the standing rigging anchor for the A.T.V. Winch.
